(19) United States
(12) Patent Application Publication
(10) Pub. No.: US 2005/0117483 A1
(43) Pub. Date: Jun. 2, 2005

(54) Optical disk apparatus and information reproducing method

(75) Inventors: Emi Maruyama, Yokohama-shi (JP); Kazuto Kuroda, Kawasaki-shi (JP); Toshihiko Kaneshige, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/995,542

(22) Filed: Nov. 24, 2004

(30) Foreign Application Priority Data
Nov. 28, 2003 (JP) 2003-400902

(51) Int. Cl. G11B 7/00

(52) U.S. Cl. 369/53.2; 369/44.28

(57) ABSTRACT

An information storage medium has a system lead-in area and a data lead-in area, and an area identifying circuit identifies whether a light beam irradiation area of an optical pickup head is at the system lead-in area or at the data lead-in area based on a reproduction signal provided from the optical pickup head. The area identifying circuit identifies the respective areas by using the number of zero crossings obtained from a signal, for example, into which the reproduction signal is binarized. An information reproducing circuit reproduces information from the reproduction signal based on the identified result by the area identifying circuit.

### CROSS-REFERENCE TO RELATED APPLICATIONS

This application is based upon and claims the benefit of priority from prior Japanese Patent Application No. 2003-400902, filed Nov. 28, 2003, the entire contents of which are incorporated herein by reference.

### BACKGROUND OF THE INVENTION

1. Field of the Invention

The present invention relates to an information reproducing method, an information reproducing apparatus, and an information recording and reproducing apparatus for an information storage medium having two lead-in areas.

2. Description of the Related Art

In a conventional read-only information storage medium (hereinafter, DVD-ROM), the entire information storage medium is an embossed area, and a lead-in area for storing attribute information or the like is provided at the innermost peripheral side, and a data area is provided at the outer peripheral side thereof. At the both areas, information is recorded due to irregularities which are called pits and are provided on the recording layer of the information storage medium.

In a conventional write-once information storage medium (hereinafter, DVD-R) as well, a lead-in area is provided at the innermost peripheral side of the information storage medium, and a data area is provided at the outer peripheral side thereof. Attribute information or the like is recorded due to land pre-pits on the lead-in area. There are guide grooves called grooves at the data area, and trial writing and defective management data are recorded on the area at the inner peripheral side. On a DVD-R, it is possible to record only one time, and information is recorded in the grooves at the data area.

In a conventional rewritable information storage medium (hereinafter, DVD-RAM) as well, a lead-in area is provided at the innermost peripheral side of an information storage medium 1, and a data area is provided at the outer peripheral side thereof. Attribute information is recorded due to land pre-pits at the lead-in area, and there are guide grooves called grooves at the data area, and a trial writing area and a defective management data recording area are provided at the inner peripheral side thereof. On a DVD-RAM, it is possible to rewrite 10,000 times or more, and information is recorded in both of the grooves and the lands at the data area. When the recorded data are reproduced, the information written in the grooves and the information written in the lands are alternately reproduced.

In this way, the physical layouts (physical formats) of information to be recorded are different from one another among the DVD-ROM, DVD-R, and DVD-RAM. In Jpn. Pat. Appln. KOKAI Publication No. 63-70984, there is disclosed a technique relating to a method for identifying/reproducing two data regions on which recordings are carried out in modulation systems different from one another, and which have physical formats different from one another.

As described above, the physical formats of information to be recorded are different from one another among various DVDs, and in particular, with respect to DVD-RAMs, there has been the problem that a DVD-RAM cannot be reproduced unless a recording and reproducing apparatus has a special factor for reproducing a DVD-RAM. Further, with respect to DVD-Rs, there has been the problem that, because the depth of embossment of a DVD-R is shallower than that of a DVD-ROM, when a recording pit length and a distance between pits at the lead-in area of the DVD-R are made to be the same as those of the DVD-ROM, the reproducing reliability of the DVD-RAM is reduced.

Moreover, recently, next generation DVDs whose recording capacities are over the recording capacities of the conventional DVD disks have been developing by DVD-related companies. In the next generation DVDs, it has been proposed that two lead-in areas whose information recording systems are different from one another are provided at the inner peripheral side of a disk.

In the above-described Jpn. Pat. Appln. KOKAI Publication No. 63-70984, there is a characteristic in which respective lead-in areas on which identification information are recorded are reproduced by using data demodulation before the two data regions are identified. Accordingly, there is the defect that the starting operation is slow.

### BRIEF SUMMARY OF THE INVENTION

According to an aspect of the present invention, there is provided an optical disk apparatus which carries out information reproduction from an optical disk having a system lead-in area, a connection area, and a data lead-in area, the apparatus comprising: an optical pickup head which irradiates a light beam onto the optical disk, and provides a reproduction signal corresponding to a reflected light of the light beam, and which can be moved in a radial direction of the optical disk; identification means for identifying whether a light beam irradiation area of the optical pickup head is at one of the system lead-in area and the data lead-in area based on the reproduction signal provided from the optical pickup head; and information reproducing means for reproducing information form the reproduction signal based on an identified result by the identification means.

With respect to the read-only, write-once, and rewritable information storage media which have plural types of lead-in areas whose recording systems are different from one another, the respective lead-in areas can be identified precisely and in a short time.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a dimensional drawing of respective areas structuring an information storage medium 1.

FIG. 2 is a data structure explanatory drawing of a lead-in area in a read-only information storage medium.

FIG. 3 is a data structure explanatory drawing of a lead-in area in a write-once information storage medium.

FIG. 4 is a data structure explanatory drawing of a lead-in area in a rewritable information storage medium.

FIG. 5 is a block diagram showing a configuration of an information recording and reproducing apparatus using the information storage medium 1 of the present invention.

FIG. 6 is a flowchart showing processing in which information is reproduced from a system lead-in area 3 by the use of a method 1.

FIG. 7 is a diagram showing a configuration of an area identifying circuit 28 used in the method 1.

FIGS. 8A and 8B are diagrams for explanation of intersymbol interference.

FIG. 9 is a diagram for explanation of an operation when a reproduction signal onto which low-frequency component is superimposed due to intersymbol interference or with another cause is binarized at a fixed slice level.

FIG. 10 is a diagram showing waveforms of respective nodes A through E of a binarizing circuit 31.

FIG. 11 is a diagram showing other waveforms of the respective nodes A through E of the binarizing circuit 31.

FIG. 12 is a diagram showing the other waveforms of the respective nodes A through E of the binarizing circuit 31.

FIG. 13 is a diagram showing signal waveforms at the peripheries of a counter 43 and a holding circuit 44.

FIG. 14 is a flowchart showing processing in which information is reproduced from the system lead-in area 3 by the use of a method 2 of the present invention.

FIG. 15 is a diagram showing a configuration of the area identifying circuit 28 used in the method 2.

FIG. 16 is a flowchart showing processing in which information is reproduced from the system lead-in area 3 by the use of a method 3 of the present invention.

FIG. 17 is a diagram showing a configuration of the area identifying circuit 28 used in the method 3.

FIG. 18 is a diagram showing signal waveforms of respective nodes of the area identifying circuit 28 shown in FIG. 17.

FIG. 19 is a flowchart showing processing in which information is reproduced from the system lead-in area 3 by the use of a method 4.

FIG. 20 is a diagram showing a configuration of the area identifying circuit 28 used in the method 4.

FIG. 21 is a flowchart showing a method for skipping over a connection area 5.

FIG. 22 is a diagram showing a configuration of a connection area skipping circuit 29.

FIG. 23 is a flowchart showing processing after skipping over the connection area 5.

### DETAILED DESCRIPTION OF THE INVENTION

Hereinafter, embodiments of the present invention will be described in detail with reference to the drawings.

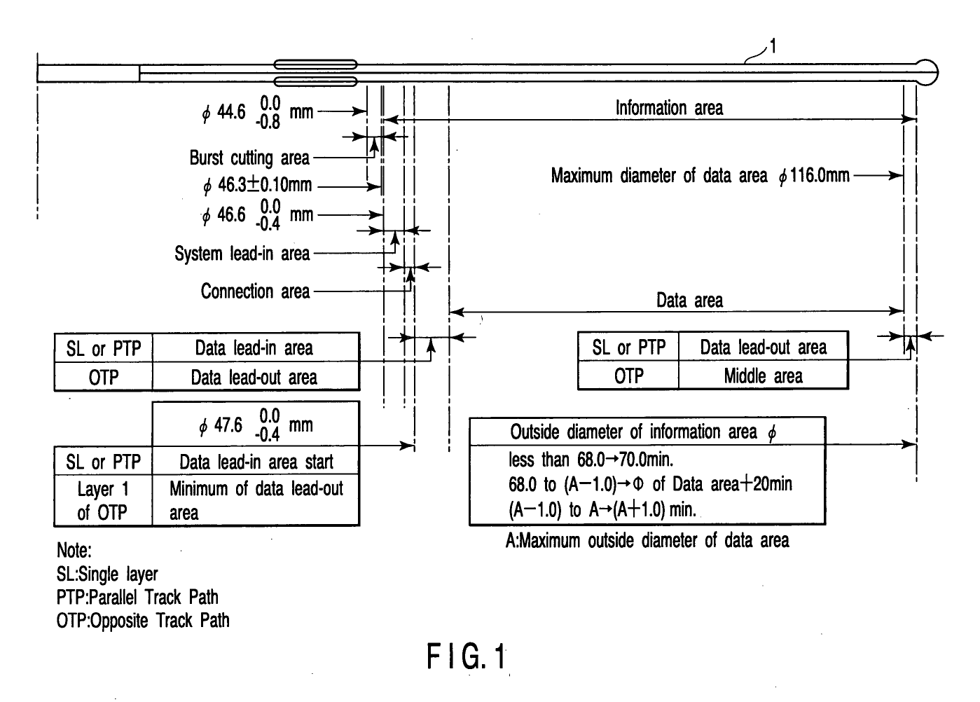

FIG. 1 is a diagram showing mechanical dimensions of a read-only/write-once/rewritable information recording medium 1 which is applied to an information recording and reproducing apparatus in accordance with the present embodiment. The information recording medium 1 has two of recording layers, and is the so-called next generation DVD disk in which the information recording densities of the respective recording layers are higher than those of the existing DVD disks. As shown in FIG. 1, in the information recording medium 1, the mechanical dimensions coincide with those of the conventional existing DVD disks in spite of whether it is a read-only, write-once, or rewritable information recording medium 1. Accordingly, there is a risk that a user may mount the information recording medium 1 on a DVD player or a DVD recorder in error, or may mount a conventional existing DVD disk on the information recording and reproducing apparatus of the present embodiment.

In that case, due to a track pitch between embossed pit tracks and a shortest embossed pit length at the system lead-in area being set to values close to that of the conventional existing DVD disk, even in a case as described above, the new medium and the old medium can be distinguished from one another, and it is possible to calculate in accordance with a type of a medium.

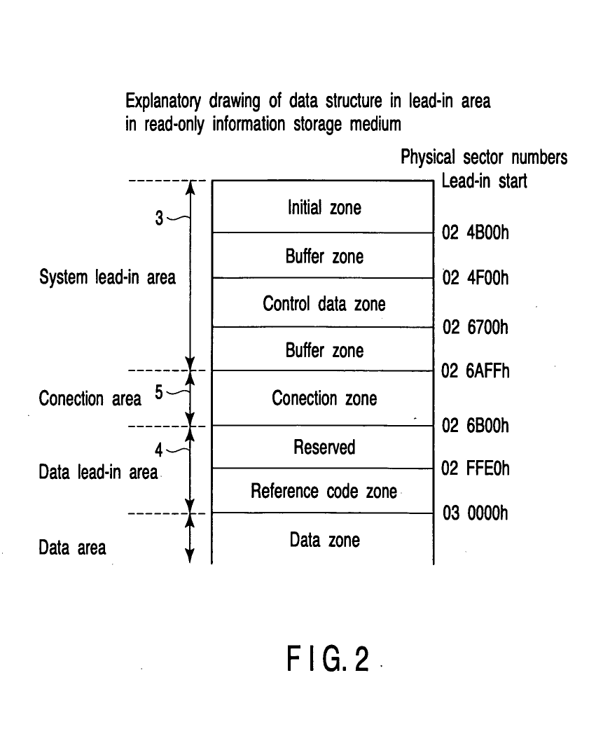

FIG. 2 is a diagram for explanation of a data structure of a lead-in area in a read-only information storage medium applied to the present embodiment. This lead-in area includes a system lead-in area, a connection area, and a data lead-in area. The lead-in area includes an initial zone, a buffer zone, a control data zone, and a buffer zone. Information is not recorded on the connection area.

A reference code zone is disposed in the data lead-in area. A reference code is used for automatic circuit adjusting (adjusting respective tap coefficient values or the like) in a reproducing circuit. Namely, the automatic circuit adjusting is carried out while reproducing the above-described reference code in advance in order to stably reproduce/detect information recorded in the data region. Accordingly, due to the reference code being disposed within the data lead-in area, the track pitch and the shortest pit length at the reference code are made to coincide with the values within the data area, and an accuracy of automatic circuit adjusting in the reproducing circuit can be improved.

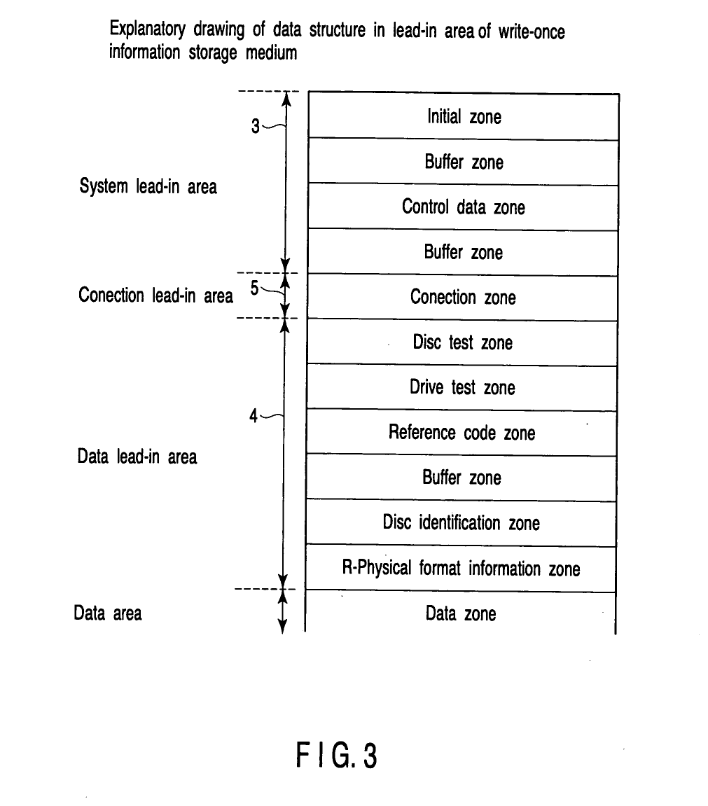

FIG. 3 is a diagram showing a data structure at a lead-in area of a write-once information storage medium applied to the present embodiment. In the write-once information storage medium, a control data zone common to various media is provided in the system lead-in area at which embossment formed pits are recorded, and in a data lead-in area at which write-once record marks are recorded, there are a disk test zone for trial writing, a drive test zone, a reference code zone at which a reference signal for reproducing circuit adjusting is recorded, a disk ID zone, and an R-physical formatted information zone.

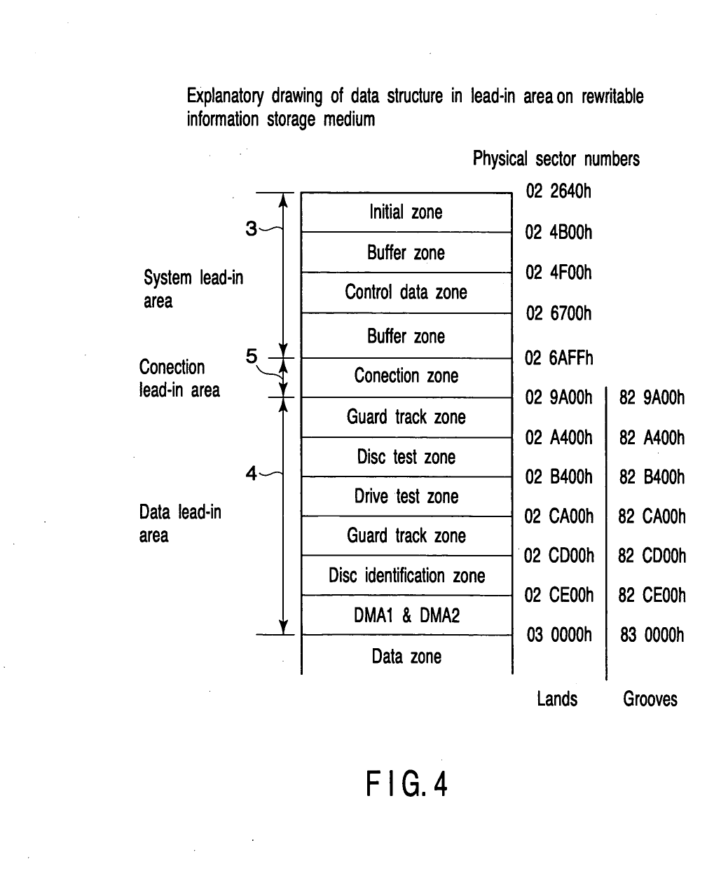

FIG. 4 is a diagram for explanation of a data structure at a lead-in area in a rewritable information storage medium applied to the present embodiment. Embossment formed pits are formed at the system lead-in area in FIG. 4, and the data lead-in area is formed from rewritable record marks.

In FIG. 4, the initial zone includes an embossed data area. Main data in a data frame recorded at the initial zone as a record data area is made to be “00h”. The buffer zone includes 32 of DCC blocks (1024 sectors). Main data in a data frame recorded on the initial zone as a physical sector is made to be “00h”. A control data zone includes the embossed data area. The data area includes emboss control data.

Because a physical sector number or a physical address is not allocated to a connection area, the connection area does not include a physical sector number or a physical address. The data segment at a guard track zone does not include data. A disk test zone is for a quality test by a disk manufacturer. A drive test zone is for a test by a drive. The information recording and reproducing apparatus carries out trial writing onto the drive test zone, and makes an attempt to optimize recording conditions. Moreover, the data lead-in area includes a disk ID zone and DMA1 & DMA2.

The lead-in areas of the read-only information storage medium, the write-once information storage medium, and the rewritable information storage medium which relate to the present invention are divided into a system lead-in area 3 and a data lead-in area 4 so as to put a connection area 5 therebetween. The data layout contents and the data layout order of the initial zone/buffer zone/control data zone/buffer zone at the system lead-in area 3 are configured so as to common to all of the information storage media 1 which are the read-only information storage medium, the write-once information storage medium, and the rewritable information storage medium. The write-once information storage medium according to the present invention can have reproducing compatibility with the read-only information storage medium and the rewritable information storage medium in accordance with the methods of the present invention. Further, by the use of the information reproducing method and the information recording and reproducing apparatus of the present invention, it is possible to access to the respective information storage media 1 according to the invention at a high-speed, and the reliability of reproducing operations can be improved.

The recording type information storage medium applied to the present embodiment is configured such that, as described above, the connection zone is disposed between the system lead-in area recorded by the use of embossed pits and the data lead-in area recorded by the use of write-once or rewritable record marks, and the connection zone is disposed so as to be at a distance between the system lead-in area and the data lead-in area. Two recording layers on which it is possible to record/reproduce from only one side are provided at the recording type information storage medium 1. There is a phenomenon called interlayer crosstalk in which, when one recording layer is being reproduced, a light reflected at the other recording layer comes into a photo detector, and the reproduction signal characteristic is deteriorated. In particular, an amount of the reflected light differs to a large extent in accordance with whether the light reflected at the other recording layer is irradiated onto the system lead-in area or onto the data lead-in area. Accordingly, when the light reflected at the other recording layer alternately comes into the system lead-in area and the data lead-in area during the time of tracing one round along the recording layer which is the object to be reproduced, in accordance with a difference in relative eccentric amounts between the two recording layers, the affect due to interlayer crosstalk. In order to avoid the problem, in the recording medium 1 is configured such that the connection zone is disposed between the system lead-in area recorded by the use of embossed pits and the data lead-in area recorded by the use of write-once or rewritable record marks, and a distance between the system lead-in area and the data lead-in area is made to be away, and a stable reproduction signal can be obtained by reducing the affect due to interlayer crosstalk.

Because there are no pits and guide grooves (grooves) on the connection area 5, a track error signal is not generated. Accordingly, when a conventional reproducing operation is carried out, track servo control for moving an objective lens along the groove runs away, and a normal reproducing operation thereafter cannot be continued. In the present invention, a reproducing operation from the system lead-in area 3 to the data lead-in area 4 can be stably carried out.

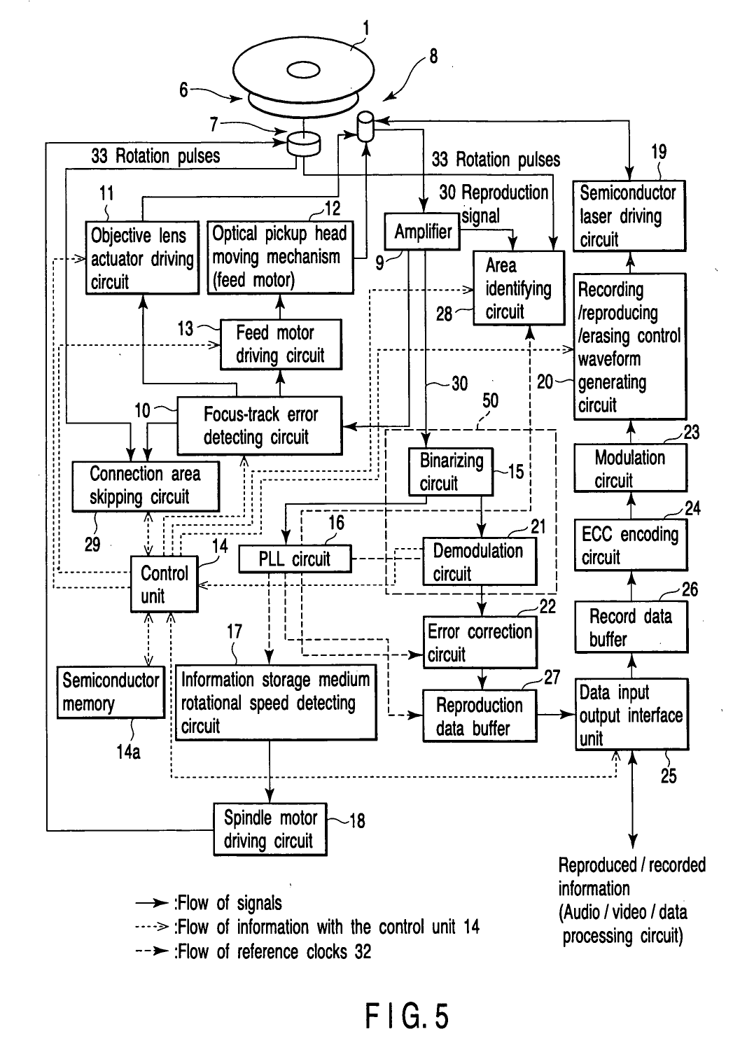

FIG. 5 is a block diagram showing a configuration of the information recording and reproducing apparatus (optical disk apparatus) using the information storage medium 1 of the present invention.

The information storage medium 1 is mounted on a rotating table 6 rotating by a driving force of a spindle motor 7. An optical pickup head 8 is composed of a semiconductor laser device, a photo detector, and an objective lens. A laser light emitted from the semiconductor laser device is condensed on the information storage medium 1 by the objective lens. The laser light reflected at a light reflective film or a light reflex recording film of the information storage medium 1 is photoelectrically converted by the photo detector.

A detected electric current obtained at the photo detector is current-voltage converted into a detection signal by an amplifier 9. Addition and subtraction are carried out with respect to this detection signal at a focus-track error detecting circuit 10, and a focus error signal and a track error signal are outputted. The focus error signal is a signal needed for the focus control of a condensed spot, and the focus-track error detecting circuit 10 detects and outputs a deviation amount (a focus error signal) of the condensed spot in the vertical direction with respect to the information storage medium 1. There are concentric circle or spiral tracks on the information storage medium 1, and information is reproduced by making the condensed spot trace along the tracks. The track error signal is a signal needed for stably making a condensed spot trace along the tracks, and the focus-track error detecting circuit 10 detects and outputs a relative deviation amount (a track error signal) between the tracks and the condensed spot.

An objective lens actuator driving circuit 11 is a driving circuit for moving the objective lens in the optical pickup head 8, and generates a driving electric current in accordance with a track error signal from the focus-track error detecting circuit 10 and an instruction from a control unit 14. The moving directions of the objective lens are the vertical direction with respect to the information storage medium 1 (for correcting a focus error signal) and the radial direction of the information storage medium 1 (for correcting a track error signal). An optical pickup head moving mechanism (feed motor) 12 is a driving circuit for moving the optical pickup head 8 in the radial direction to an arbitrary position on the information storage medium 1. A circuit supplying a driving electric current to the optical pickup head moving mechanism (feed motor) 12 is a feed motor driving circuit 13, and a driving electric current is generated in accordance with a track error signal from the focus-track error detecting circuit 10 and an instruction from the control unit 14.

Focus Servo and Track Servo Control

The objective lens actuator driving circuit 11 supplies a driving electric current to the optical pickup head 8 such that a focus error signal and a track error signal are made to be minimum values in the process of reproducing. The feed motor driving circuit 13 supplies a driving electric current to the optical pickup head moving mechanism (feed motor) 12 such that a track error signal is made to be a minimum value in the process of reproducing. It is called focus servo control that a focus is controlled so as to make a focus error signal be a minimum value, and a period of time of the control is called focus servo ON, and a period of time of stopping the control is called focus servo OFF. It is called track servo control that track tracing is controlled so as to make a track error signal be a minimum value, and a period of time of the control is called track servo ON, and a period of time of stopping the control is called track servo OFF. Start instructions and stop instructions of these servo controls are transmitted to the objective lens actuator driving circuit 11 and the feed motor driving circuit 13 from the control unit 14.

The information storage medium 1 is mounted such that the central position thereof is at an eccentric position which is slightly deviated from the central position of a rotating table 21. When the information storage medium 1 is reproduced continuously for a long time, the position of a condensed spot gradually moves in the outer peripheral direction or the inner peripheral direction. The track servo control of the feed motor driving circuit 13 is effective in eliminating the effect due to the eccentricity of the information storage medium 1, and the optical pickup head 8 is moved in units larger than a movable distance of the objective lens. The track servo control of the objective lens actuator driving circuit 11 is for controlling the objective lens, and moves the objective lens in units of tracks at a high-speed.

Moving Control of the Optical Pickup Head 8 to Target Position

Before moving the optical pickup head 8, the control unit 14 instructs the objective lens actuator driving circuit 11 and the feed motor driving circuit 13 to turn track servo off. The feed motor driving circuit 13 calculates a difference between a disk rotational speed at the condensed spot obtained from the focus-track error detecting circuit 10 and target speed information from the control unit 14, and supplies a driving electric current of which the calculated result is taken into consideration to the optical pickup head moving mechanism (feed motor) 12. In accordance therewith, the optical pickup head moving mechanism (feed motor) 12 moves the optical pickup head 8 to the target position.

After the optical pickup head 8 is made to move to the target position, the objective lens actuator driving circuit 11 adjusts the reproducing position more accurately. The control unit 14 instructs the objective lens actuator driving circuit 11 and the feed motor driving circuit 13 to turn track servo on, and obtains a current address or a track number of the condensed spot. The control unit 14 calculates a track error between the reproducing position and the current position, and notifies the objective lens actuator driving circuit 11 of the number of tracks needed for the movement. The objective lens actuator driving circuit 11 turns track servo off, and moves the objective lens from the current position based on the number of tracks inputted from the control unit 14, and turns track servo on after the movement. Finally, the control unit 14 reproduces the current address or the track number of the condensed spot, and confirms that the target track is being accessed.

Reference Clock Generating Circuit

An analog signal outputted from the amplifier 9 is converted into a digital signal at a binarizing circuit 15. At the binarizing circuit 15, an input signal is converted into binary information which is higher or lower as compared with a certain electric potential. The electric potential to be a comparative origin is called a slice level, and a point at which the slice level and the input signal coincide with one another is called a zero crossing. The binarized signal is inputted to a PLL circuit 16, and a constantly periodic signal whose fixation coincides with that of the output signal from the binarizing circuit 15 is outputted from the PLL circuit 16. The constantly periodic signal outputted from the PLL circuit 16 is used as a reference clock of a digital signal processing circuit handling the binarized signal of a demodulation circuit 21 or the like after being reproduced. A reproducing circuit 50 including the binarizing circuit 15 and the demodulation circuit 21 is information extracting means for extracting information from a reproduction signal in accordance with a PRML system.

Rotation Control of Spindle Motor 7

An information storage medium rotational speed detecting circuit 17 counts reference clocks 32 from the PLL circuit 16 in order to detect a rotation speed of the information storage medium 1. At the time of reproducing or recording/erasing, the control unit 14 refers to a semiconductor memory 14a in which there is a table of rotation speeds of the information storage medium 1 corresponding to the radial position thereof, and notifies a spindle motor driving circuit 18 of a target rotation speed of the information storage medium 1 obtained from the table. The spindle motor driving circuit 18 calculates a difference between the target rotation speed and the rotation speed of the information storage medium 1 from the information storage medium rotational speed detecting circuit 17, and supplies a driving electric current of which the calculated result is taken into consideration to the spindle motor 7, and controls the number of the spindle motor 7 to be constant.

Laser Light Quantity Control

Switching of reproducing, recording, and erasing information on the information storage medium 1 are carried out by varying a quantity of light of a condensed spot irradiated onto the information storage medium 1.

When information is being reproduced, a constant quantity of light is successively irradiated onto the information storage medium 1.

When information is recorded, a quantity of a pulse formed intermittent light is added to the quantity of light at the time of reproducing. When the semiconductor laser device emits a pulse at a large quantity of light, the light reflex recording film of the information storage medium 1 locally brings about an optical change or a variation in shape, and record marks are formed thereon. In a case of overwriting on the area which has been recorded as well, the semiconductor laser device is made to emit a pulse in the same way.

When the information which has been recorded is erased, a constant quantity of light larger than that at the time of reproducing is successively irradiated. When the information is successively erased, a quantity of irradiation light is returned to the quantity of light at the time of reproducing at each specific period such as sector units or the like, and information reproducing is intermittently carried out in parallel with erasing processing, and it is confirmed from a track number or an address that there is no error in the track to be erased.

A photo detecting circuit for detecting a quantity of emitted light of the semiconductor laser device is built in the optical pickup head 8. The semiconductor laser driving circuit 19 supplies a driving electric current for the semiconductor laser to the optical pickup head 8 based on a result into which a difference between the output from the photo detecting circuit and a light emitting reference signal supplied from a recording/reproducing/erasing control waveform generating circuit 20 is calculated.

Reproduction signal from Information Storage Medium 1 and Recording Signal to Information Storage Medium 1

At the time of recording, after the information to be recorded on the information storage medium 1 is preliminarily treated at a data input output interface unit 25, the information is inputted to a record data buffer 26. An ECC encoding circuit 24 adds an ECC (Error Correction Code) to the data read out of the record data buffer 26. The ECC is a redundant code to be added in order to detect and correct an error in data. The data to which the ECC is added is inputted to a modulation circuit 23. In the modulation circuit 23, signal modulation is carried out in order to eliminate the DC component in the signal at the time of reproducing, and to record information at a high density with respect to the information storage medium 1. The modulation circuit 23 divides the data inputted from the ECC encoding circuit 24 at every certain bit in accordance with the modulation system, and those are converted into the other data with reference to the conversion table. In the recording/reproducing/erasing control waveform generating circuit 20, recording waveforms are generated from the data inputted from the modulation circuit 23, and are inputted to the semiconductor laser driving circuit 19.

At the time of reproducing, a variation in a quantity of reflected light from the light reflective film or the light reflex recording film is detected at the optical pickup head 8, and is processed at the amplifier 9 and the binarizing circuit 15, and is converted into binarized signal. The demodulation circuit 21 demodulates signals based on the reference clocks 32 obtained at the PLL circuit 16 and the conversion table. The conversion table which the demodulation circuit 21 has corresponds to the modulation circuit 23. The demodulated signals are recorded in a reproduction data buffer 27. An error correction circuit 22 reads out the data from the reproduction data buffer 27, and carries out error correction and ECC decoding.

Starting Control of Information Recording and Reproducing Apparatus

1) The control unit 14 notifies the spindle motor driving circuit 18 of the target rotation speed. A driving electric current is supplied from the spindle motor driving circuit 18 to the spindle motor 7, and rotations of the spindle motor 7 start.
2) The control unit 14 notifies the feed motor driving circuit 13 of an instruction, and A driving electric current is supplied from the feed motor driving circuit 13 to the optical pickup head moving mechanism (feed motor) 12, and the optical pickup head moving mechanism (feed motor) 12 moves the optical pickup head 8 to the innermost peripheral position of the information storage medium 1. It is confirmed that there is the optical pickup head 8 at a burst cutting area 2 over the area at which the information of the information storage medium 1 has been recorded.
3) When the spindle motor 7 rotates the target rotation speed, the state is notified to the control unit 14.
4) An electric current is supplied to the semiconductor laser device in the optical pickup head 8 from the semiconductor laser driving circuit 19 based on an amount of signals in the quantity of reproduced light of which the control unit 14 has notified the recording/reproducing/erasing control waveform generating circuit 20, and the semiconductor laser device starts to emit a laser light. However, an optimum quantity of irradiation light at the time of reproducing varies in accordance with a type of the information storage medium 1. Accordingly, an initial value of the quantity of irradiation light is at the minimum level.
5) The control unit 14 notifies the objective lens actuator driving circuit 11 of an instruction, and the objective lens actuator driving circuit 11 moves the objective lens in the optical pickup head 8 to a position which is furthest away in the vertical direction from the information storage medium 1, and next, the objective lens actuator driving circuit 11 controls the objective lens to be closer to the information storage medium 1 at a low speed.
6) A focus deviation amount is observed at the focus-track error detecting circuit 10, and when the objective lens reaches the focal point position, the state is notified to the control unit 14. When the control unit 14 receives this notification, the control unit 14 notifies the objective lens actuator driving circuit 11 of an instruction to turn focus servo on.
7) The control unit 14 notifies the feed motor driving circuit 13 of an instruction, and the feed motor driving circuit 13 moves the optical pickup head 8 in the outer peripheral direction of the information storage medium 1.
8) The reproduced signal is monitored, and when the optical pickup head 8 reaches a position in the outer peripheral direction from the burst cutting area 2 on the information storage medium 1, the movement of the optical pickup head 8 is stopped.
9) Track servo is turned on.
10) The system lead-in area 3 and the data lead-in area 4 of the information storage medium 1 are reproduced. For example, “Optimum quantity of light at the time of reproducing” information and “Optimum quantity of light at the time of recording/erasing” information which have been recorded on the information storage medium 1 are written in the semiconductor memory 14a via the control unit 14. The control unit 14 notifies the recording/reproducing/erasing control waveform generating circuit 20 of the information on “Optimum quantity of light at the time of reproducing”, and resets a quantity of emitted light of the semiconductor laser device at the time of reproducing.
   Termination Control of Information Recording and Reproducing Apparatus
1) The control unit 14 notifies the objective lens actuator driving circuit 11 and the feed motor driving circuit 13 of an instruction of the track servo OFF, and truck servo is turned off.
2) The control unit 14 notifies the objective lens actuator driving circuit 11 of an instruction of the focus servo OFF, and focus servo is turned off.
3) The control unit 14 notifies the recording/reproducing/erasing control waveform generating circuit 20 of an instruction to stop emitting light of the semiconductor laser device, and the light emitting of the semiconductor laser device is stopped.
4) The control unit 14 notifies the spindle motor driving circuit 18 of 0 as the target rotation speed.

In the reproducing of the system lead-in area 3 and the data lead-in area 4 in the control of starting the information recording and reproducing apparatus, identification the respective areas and stable skipping over the connection area 5 are required. Hereinafter, an area identifying circuit 28 and a connection area 5 skipping circuit 29 which are needed for reproducing information from the system lead-in area 3 and the data lead-in area 4 will be described.

A method for reproducing information from the system lead-in area 3 by using the identifying circuit 28 will be described.

A signal inputted to the identifying circuit 28 of FIG. 5 is a reproduction signal 30 which is detected by the optical pickup head 8, and in which the amplitude thereof is adjusted and noise is eliminated by the amplifier 9. As area identifying methods by using the identifying circuit 28, here, there are provided four types of methods shown hereinafter.
1) A method for identifying in accordance with the number of zero crossings of a signal into which the reproduction signal 30 is binarized.
2) A method for identifying in accordance with the number of zero crossings of a signal into which the reproduction signal 30 is binarized by a reference electric potential, and the number of zero crossings of a signal into which the reproduction signal 30 is binarized by different slice levels.
3) A method for identifying in accordance with a record mark length.
4) A method for identifying in accordance with the numbers of zero crossings of a signal which is binarized by a slice level with a hysteresis characteristic and a signal which is binarized by a slice level without a hysteresis characteristic.

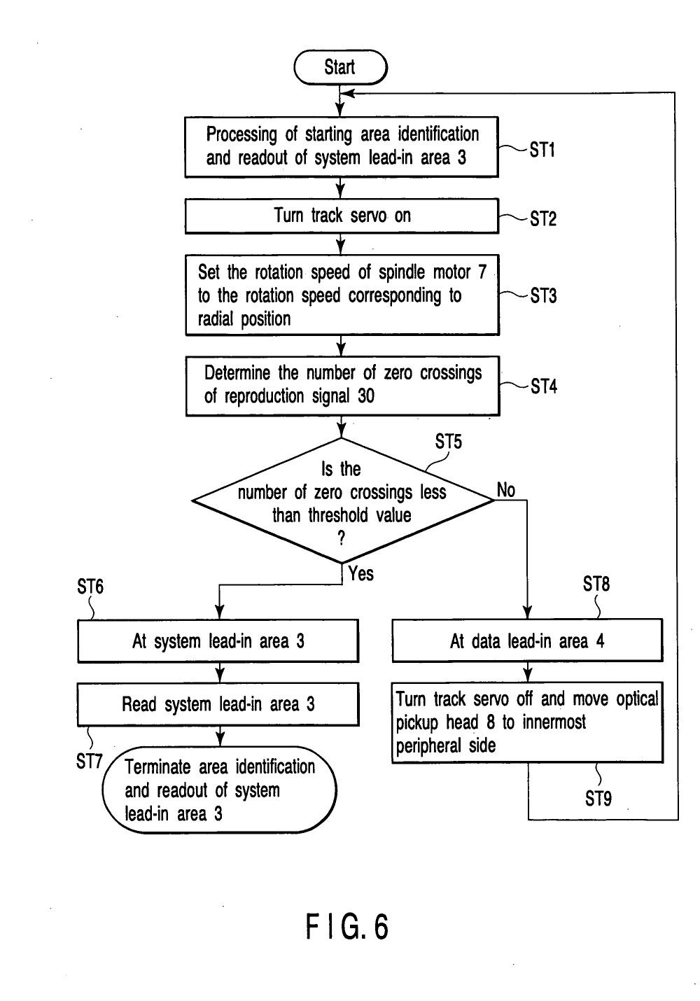

FIG. 6 is a flowchart explaining processing up to the time when information is reproduced from the system lead-in area 3 by the use of a method (hereinafter, a method 1) for identifying the areas by using the number of zero crossings obtained from a signal into which the reproduction signal 30 is binarized. Hereinafter, the method 1 will be described.

Processing of starting area identification and system lead-in area readout (ST1) shows processing in which the control unit 14 moves the optical pickup head 8 to the vicinity of the system lead-in area 3 from the burst cutting area 2 in a state of the focus servo ON. Next, the control unit 14 turns track servo on (ST2), and sets the rotation speed of the spindle motor 7 to the rotation speed corresponding to the radial position of the information storage medium 1 (ST3). Next, the number of zero crossings of the reproduction signal 30 is determined at the area identifying circuit 28 (ST4).

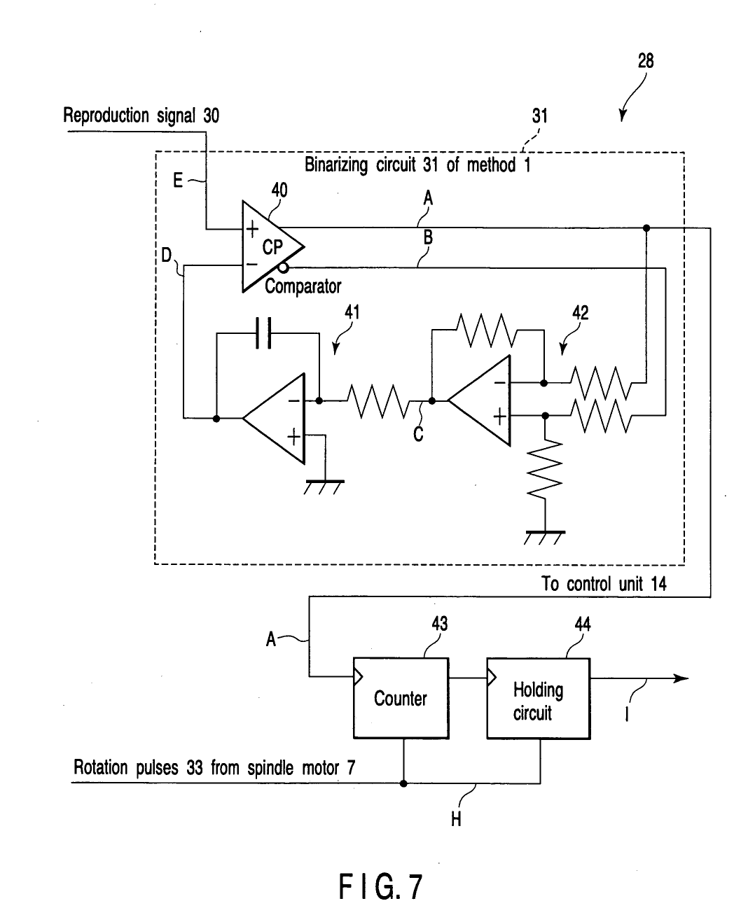

FIG. 7 is a circuit diagram showing a configuration of the area identifying circuit 28 used in the method 1. Here, the reproduction signal 30 is converted into a binarized signal by a binarizing circuit 31 relating to the method 1, and the number of zero crossings per a predetermined rotation angle of the information storage medium 1 is determined by a counter 43. The predetermined rotation angle of the information storage medium 1 is arbitrarily determined. In order to obtain the information on the rotation, rotation pulses 33 are inputted to the area identifying circuit 28 from the spindle motor 7. With respect to the rotation pulses 33, one pulse is outputted, for example, at every predetermined rotation angle of the spindle motor 7.

Here, a difference between the reproduction signals from the system lead-ion area and the data lead-in area will be described. As described above, the track pitch between the embossed pits and the shortest embossed pit length at the system lead-in area are set to values close to the embossed pit dimensions at the lead-in areas of the existing DVD disks, and therefore, the information recording density is in the same way. On the other hand, the information recording density at the data lead-in area is higher than the recording density at the system lead-in area. Accordingly, the reproduction signal frequency of the information recorded on the data lead-in area is higher, for example, about several times, than the reproduction signal frequency of the information recorded on the system lead-in area.

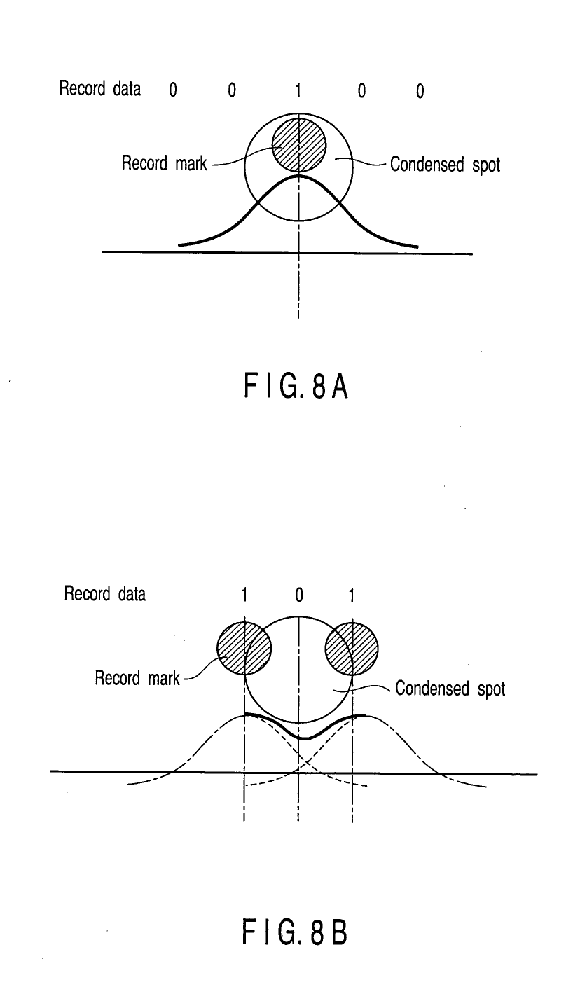

Further, there is no intersymbol interference in the reproduction signal from the system lead-in area. However, the reproduction signal from the data lead-in comes under the influence of intersymbol interference. FIG. 8A and FIG. 8B are diagrams for explanation of intersymbol interference, and the ordinates thereof denote signal strength, and the abscissas thereof denote distance or time. As shown in FIG. 8A, the reproduction signal from a single record mark has broadening under the influence of the condensed spot strength distribution. FIG. 8B shows reproduction waveforms when a distance between the record marks is smaller than a condensed spot size. In this way, when the distance between the record marks is narrow, the reproduction signal has a waveform coming under the influence of intersymbol interference. At the data lead-in area, the reproduction signal comes under the influence of intersymbol interference because the distance between the record marks is short.

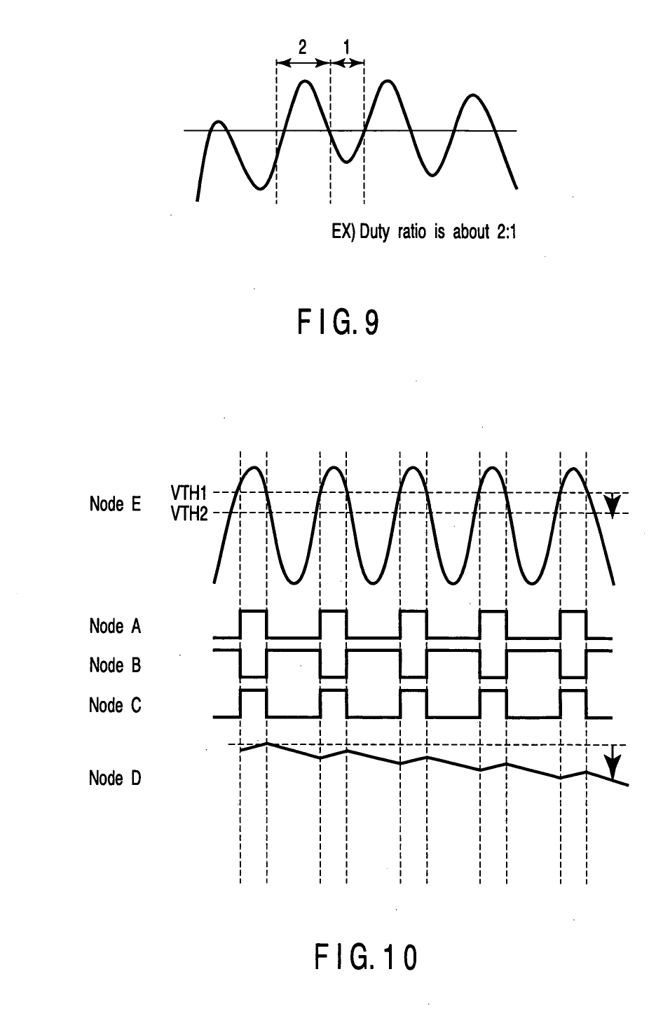

FIG. 9 is a diagram for explanation of an operation when a reproduction signal in which the above-described intersymbol interference is brought about or onto which low-frequency component is superimposed is binarized at a fixed slice level.

When the reproduction signal onto which low-frequency component is superimposed at a slice level fixed by a certain electric potential, the duty ratio (in this example, about 2:1) is biased, and stable binarization cannot be carried out. The binarizing circuit 31 shown in FIG. 7 includes a comparator 40, an integrator 41, and a differential amplifier 42, and is suitable for binarizing the reproduction signal onto which low-frequency component is superimposed as shown in FIG. 9.

The differential amplifier 42 is provided for eliminating noise in common mode component. The integrator 41 averages signals inputted up to a point in time. The binarizing circuit 31 carries out binarization by eliminating the influence of the DC component (low-frequency component) included in the reproduction signal 30 due to the reproduction signal 30 being binarized based on the output signal (the average value of the input signals) from the integrator.

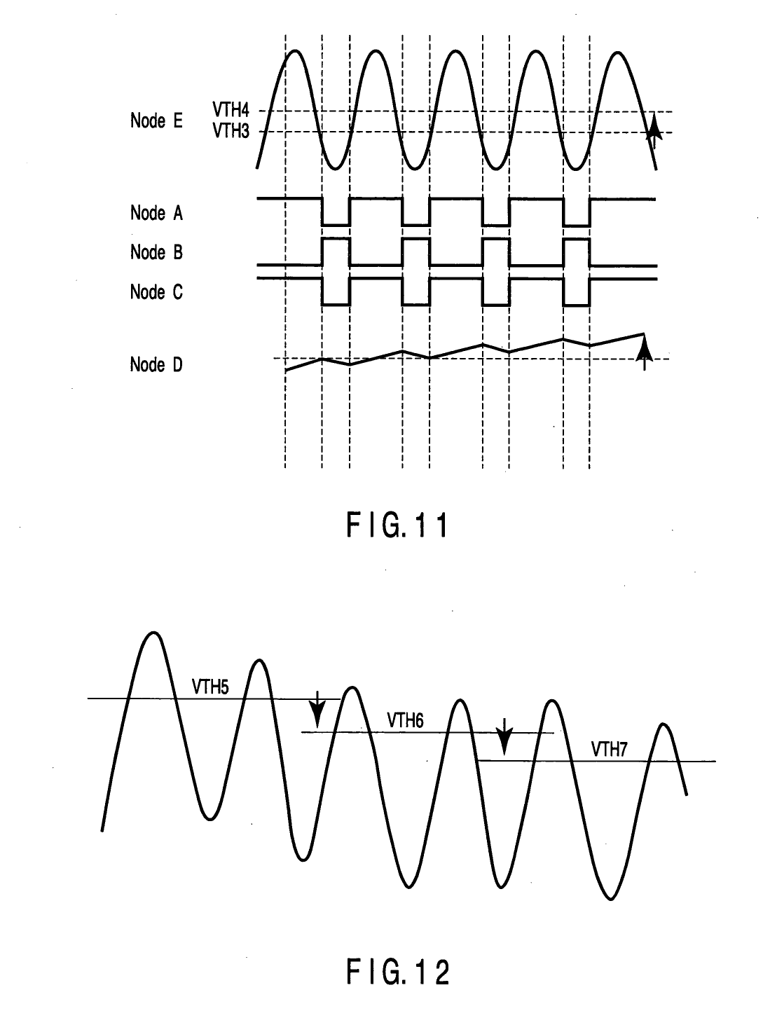

FIG. 10 through FIG. 12 show waveforms of respective nodes A through E of the binarizing circuit 31 under various conditions. In order to simplify the description, in FIG. 10 and FIG. 11, it is assumed that noise in the low-frequency component is not superimposed onto the reproduction signal.

FIG. 10 is a diagram showing an operation when an initial slice level (node D: a threshold voltage of the output from the integrator 41) is higher than a desired level (a level that the duty ratio is 1:1). When the initial slice level is at VTH1, the period in which the waveform of the node C is being greater than or equal to the slice level is short. In the integrator 41, a discharging period is longer than a charging period, and a voltage of the node D is gradually reduced. As a result, the slice level falls down from VTH1 to VTH2, and is set to a desired value.

FIG. 11 is a diagram showing an operation when an initial slice level is lower than a desired level (a level that the duty ratio is 1:1). When the initial slice level is at VTH3, a period in which the waveform of the node C is greater than or equal to the slice level is long, and in the integrator 41, the discharging period is shorter than the charging period, and the voltage of the node D is gradually increased. As a result, the slice level rises up from VTH3 to VTH4, and is set to a desired value. When the slice level is set to the desired value, the duty ration is made to be 1:1, and the charging period and the discharging period in the integrator 41 are made to be in a state of being in equilibrium.

FIG. 12 is a diagram for explanation of an operation in which the reproduction signal onto which low-frequency component is superimposed is binarized. When the reproduction signal is at a level (VTHS) higher than the desired slice level under the influence of the low-frequency component as well, the slice level falls down to VTH6 and VTH 7 due to the effect of averaging sum signals by the integrating circuit described above. As a result, an appropriate slice level is always set.

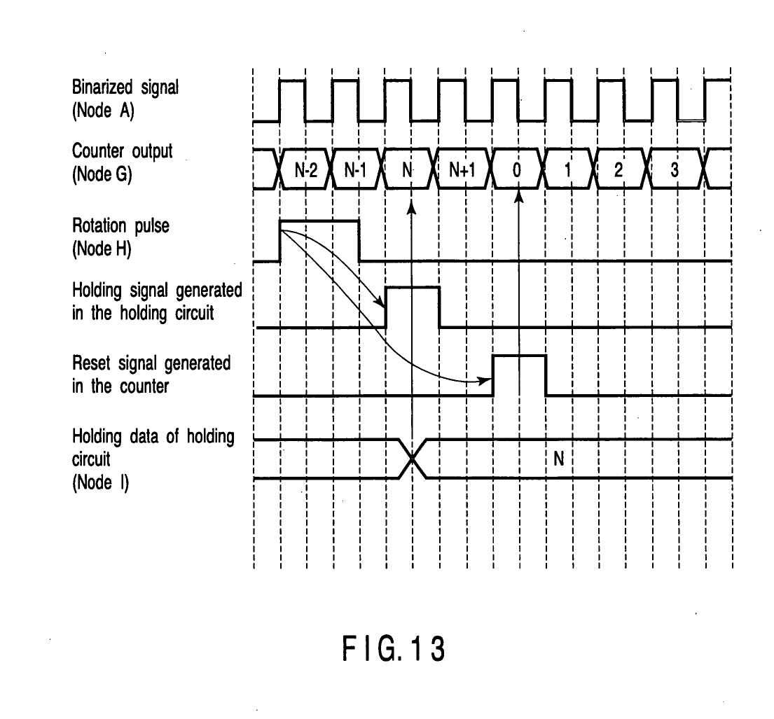

Next, operations at the peripheries of the counter 43 and a holding circuit 44 of the area identifying circuit 28 of FIG. 7 will be described. FIG. 13 is a diagram showing signal waveforms at the peripheries of the counter 43 and the holding circuit 44. A binarized signal (a signal on the node A) is inputted as a clock input to the counter 43. The rise and the fall of the binarized signal show the points at which a slice level (a node D voltage) and a voltage of the input signal (the reproduction signal 30) coincide with one another, and are the above-described zero crossing points. Accordingly, the number of zero crossings is equal to the number of pulses of the binarized signal per a predetermined number of rotation of the spindle motor (i.e., the information storage medium 1). In other words, the number of zero crossings is equal to the number of pulses of the binarized signals generated during the time when the recording medium rotates a predetermined angle.

When the rotational pulses 33 (a signal on the node H) denoting rotations of the spindle motor are inputted, the holding circuit 44 generates a holding signal at the inside thereof, and the counter 43 generates a counter reset signal at the inside thereof. Then, the holding circuit 44 holds a counted value and the counter 43 is reset in a timing made to synchronize with the rotational pulse from the spindle motor.

The control unit 14 reads a predetermined threshold value of the number of zero crossings out of the semiconductor memory 14a, and compares the threshold value with the number of zero crossings which has been held by the holding circuit 44 (ST5). The predetermined threshold value (the number of zero crossings) used in the method 1 is made to be, for example, an median value of the number of zero crossings at the system lead-in area 3 and the number of zero crossings at the data lead-in area 4 which have been measured in advance. In this way, the threshold value which is referred in the present embodiment and various embodiments which will be described later is stored in a semiconductor memory 14a, and the semiconductor memory 14a functions as a threshold value storing unit.

When the number of zero crossings is less than the predetermined threshold value, it is determined that the position of the optical pickup head 8 (the irradiation position of a light beam on the disk) is at the system lead-in area 3 (ST6), and the control unit 14 carries out switching of processings in the reproducing circuit 50 (the binarizing circuit 15 and the demodulation circuit 21) at the following stage, and reads information from the system lead-in area 3 (ST7), and the area identification and the readout of the system lead-in area 3 are completed.

When the number of zero crossings is greater than the threshold value, it is determined that the position of the optical pickup head 8 is at the data lead-in area 4 (ST8). The control unit 14 turns track servo off, and moves the optical pickup head 8 up to the burst cutting area 2 at the innermost peripheral side of the disk (ST9).

Here, the above-described reproducing circuit 50 will be described. The reproducing circuit 50 includes the binarizing circuit 15 and the demodulation circuit 21 of FIG. 5 as described above, and extracts the information from the reproduction signal 30 by carrying out PRML (Partial Response and Maximum Likelihood) signal processing. Further, as described with reference to FIG. 8, the reproduction signal at the data lead-in area comes under the great influence of intersymbol interference, and the PRML signal processing is required to be carried out in order to read the reproduction signal as data. On the other hand, at the system lead-in area, data can be read out by the conventional binarizing circuit as described above. However, in a case of the present embodiment, a reproduction signal at the system lead-in area is read out in accordance with the PRML processing. In this case, the system lead-in area and the data lead-in area are required to be set to different processing parameters. Accordingly, the control unit 14 carries out area identification before reading out the data, and switches processings in the reproducing circuit 50 at the following stage. This “switching of processings” means to set (or change) processing parameters of the reproducing circuit 50.

As described above, in accordance with the present embodiment, before the data contents are analyzed by using the reproducing circuit 50, it is identified whether the irradiation position of a beam of the optical pickup head 8 is at the system lead-in area 3 or at the data lead-in area 4, and the processing parameters of the reproducing circuit 50 are switched so as to be optimum for the respective areas. Accordingly, it is easy to improve the accuracy of decoding the respective lead-in areas. As a result, a time from the starting of the information reproducing apparatus and the information recording and reproducing apparatus up to the time of reading out the data area can be reduced.

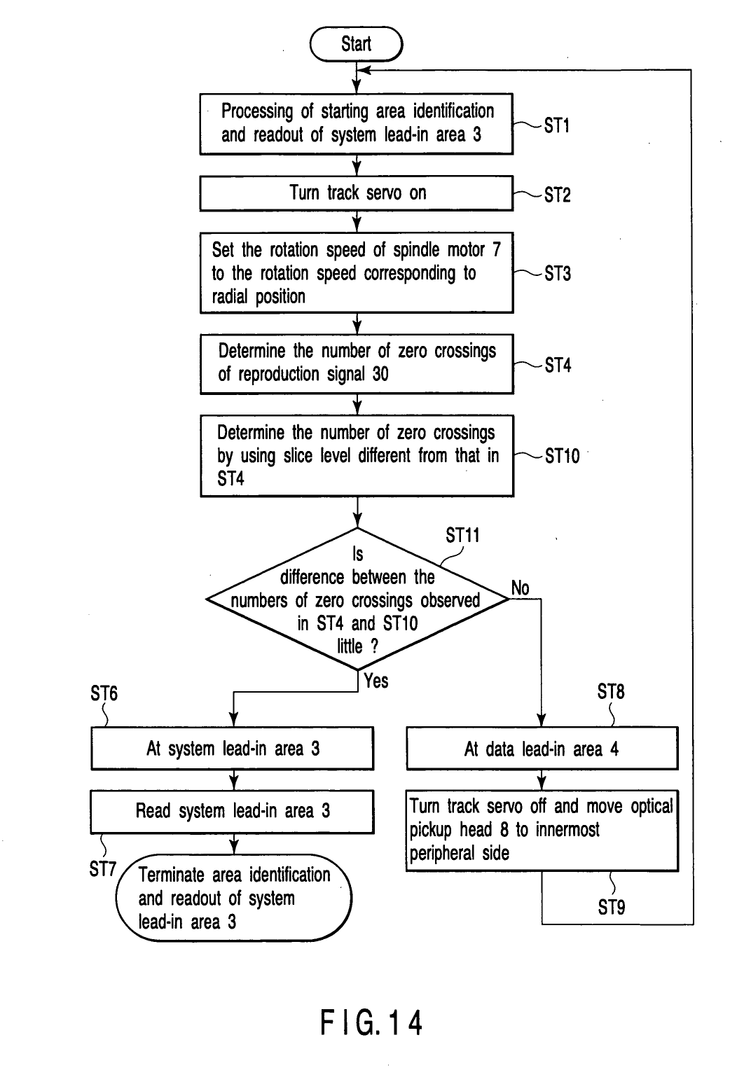

Next, a second embodiment in accordance with the present invention will be described. FIG. 14 is a flowchart showing processing up to the time when information is reproduced from the system lead-in area 3 by the use of a method (hereinafter, a method 2) for identifying based on the number of zero crossings of the signal into which the reproduction signal 30 is binarized by a reference electric potential and the number of zero crossings of the signal into which the reproduction signal 30 is binarized by a slice level different from the reference electric potential, among the area identifying methods of the present invention. Hereinafter, the method 2 will be described.

Processing of starting area identification and system lead-in area readout (ST1) shows processing in which the control unit 14 moves the optical pickup head 8 to the vicinity of the system lead-in area 3 from the burst cutting area 2 in a state of the focus servo ON. Next, the control unit 14 turns track servo on (ST2), and set the rotation speed of the spindle motor 7 to the rotation speed corresponding to the radial position of the information storage medium 1 (ST3). Next, the number of zero crossings of the reproduction signal 30 is observed (ST4). Next, the number of zero crossings is observed by using a slice level different from that in step ST4 (ST10).

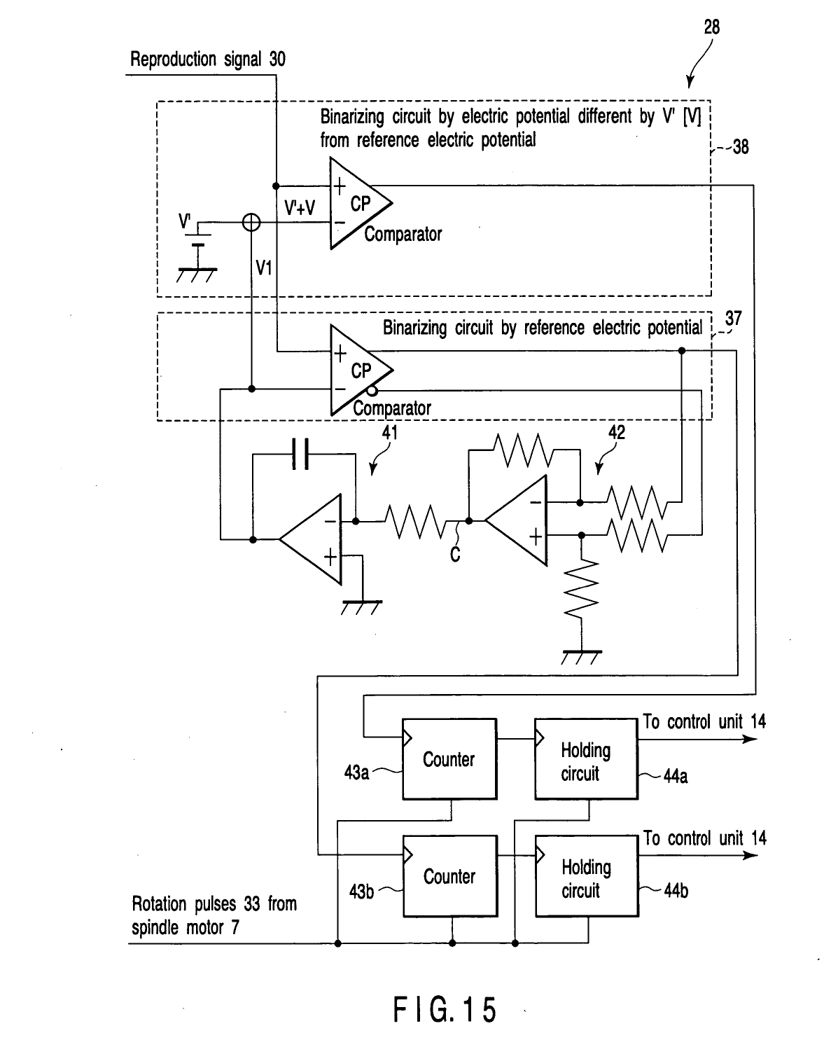

FIG. 15 is the area identifying circuit 28 used in the method 2. The reproduction signal 30 is converted into a binarized signal by a reference electric potential V1 by a binarizing circuit 37, and moreover, the reproduction signal 30 is converted into a binarized signal by using a binarizing circuit 38 referring to a slice level (V′+V1) different from the reference electric potential V1, and the numbers of zero crossings per a predetermined rotation angle of the information storage medium 1 are respectively determined by counters. The predetermined rotation angle of the information storage medium 1 is arbitrarily determined. In order to obtain the information on the rotation, the rotation pulses 33 are inputted to the area identifying circuit 28 from the spindle motor 7. A effective difference V′ between the two slice levels is determined, for example, by an experiment, so as to have a significant difference between the system lead-in area 3 and the data lead-in area 4 when the effective difference amount of the numbers of zero crossings at the two counters are compared with one another.

The low-frequency component superimposed onto the reproduction signal from the data lead-in area 4 is greater than that in the case of the system lead-in area 3 as described above. Accordingly, when the reproduction signal 30 is binarized by different slice levels, a difference between the numbers of zero crossings at the data lead-in area 4 is greater than that in the case of the system lead-in area 3.

The control unit 14 reads the numbers of zero crossings via holding circuits 44a and 44b from two counters 43a and 43b of the area identifying circuit 28 used in the method 2, and calculates the difference amount. Next, the control unit 14 reads the threshold value of the difference amount of the numbers of zero crossings from the semiconductor memory 14a, and compares the threshold value with the difference amount which is the calculated result. The threshold value used in the method 2 is made to be a median value of the difference amounts of the numbers of zero crossings which have been determined in advance at the system lead-in area 3 and the data lead-in area 4.

When the difference is little, it is determined to be the system lead-in area 3 (ST6), and information is read out of the system lead-in area 3 (ST7), and the area identification and the readout of the system lead-in area 3 are completed. When the difference is great, it is determined to be the data lead-in area 4 (ST8). The control unit 14 turns track servo off, and moves the optical pickup head 8 up to the burst cutting area 2 at the innermost peripheral side of the disk (ST9).

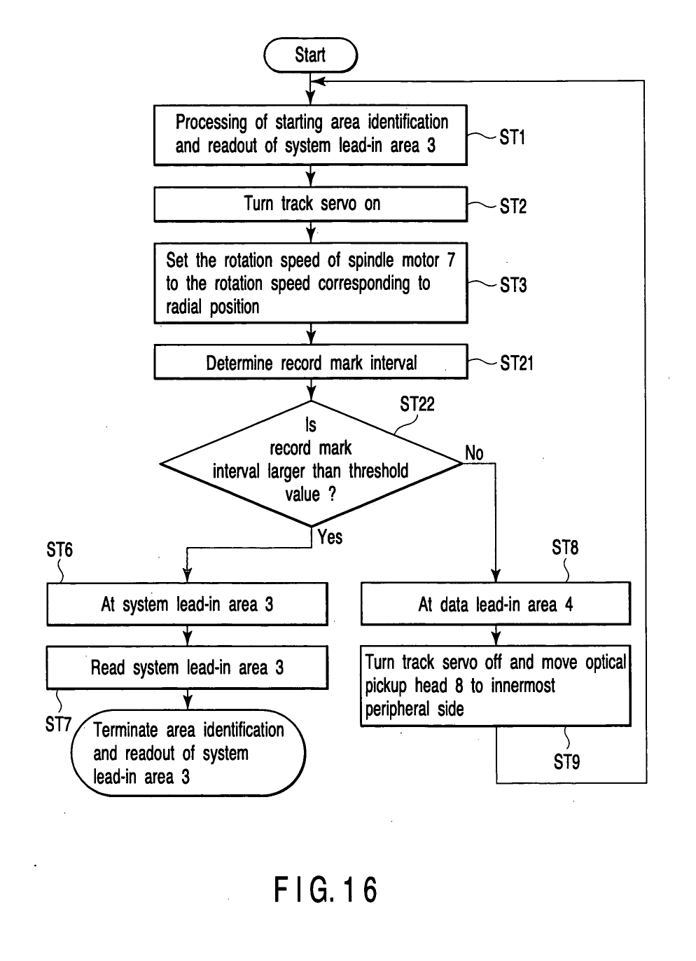

FIG. 16 is a flowchart showing processing up to the time when information is reproduced from the system lead-in area 3 by the use of a method (hereinafter, a method 3) for identifying based on a record mark length, among the area identifying methods of the present invention. Hereinafter, the method 3 will be described.

Processing of starting area identification and system lead-in area readout (ST1) shows processing in which the control unit 14 moves the optical pickup head 8 to the vicinity of the system lead-in area 3 from the burst cutting area 2 in a state of the focus servo ON. Next, the control unit 14 turns track servo on (ST2), and sets the rotation speed of the spindle motor 7 to the rotation speed corresponding to the radial position of the information storage medium 1 (ST3). Next, an interval between the record marks is determined (S21).

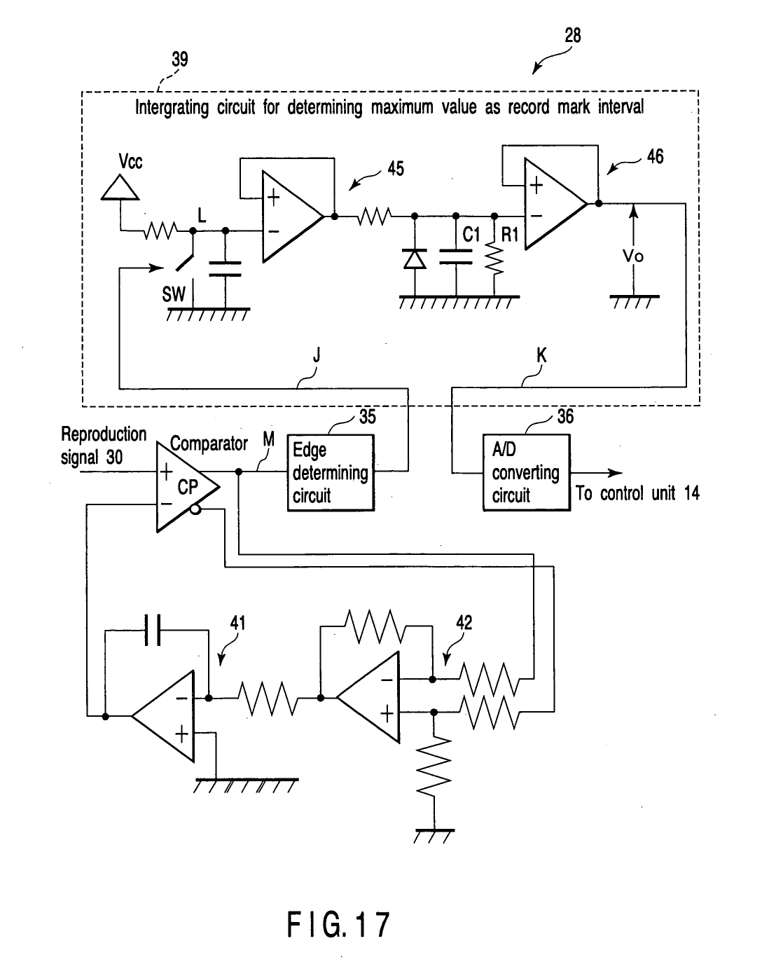

FIG. 17 is the area identifying circuit 28 used in the method 3. This circuit includes an integrating circuit 39 for determining a maximum value as a record mark interval, a circuit 35 in which the reproduction signal 30 is binarized and edge-detected, and an A/D converting circuit 36. The integrating circuit 39 in the method 3 short-circuits an SW at the falling-edge of the reproduction signal 30, and opens the SW at the rising-edge, and therefore, a voltage in proportion to the record mark length is outputted from a first stage circuit 45. Because a second stage circuit 46 functions so as to maintain the maximum electric potential of the first stage circuit 45, Vo is in proportion to the maximum value of the record mark.

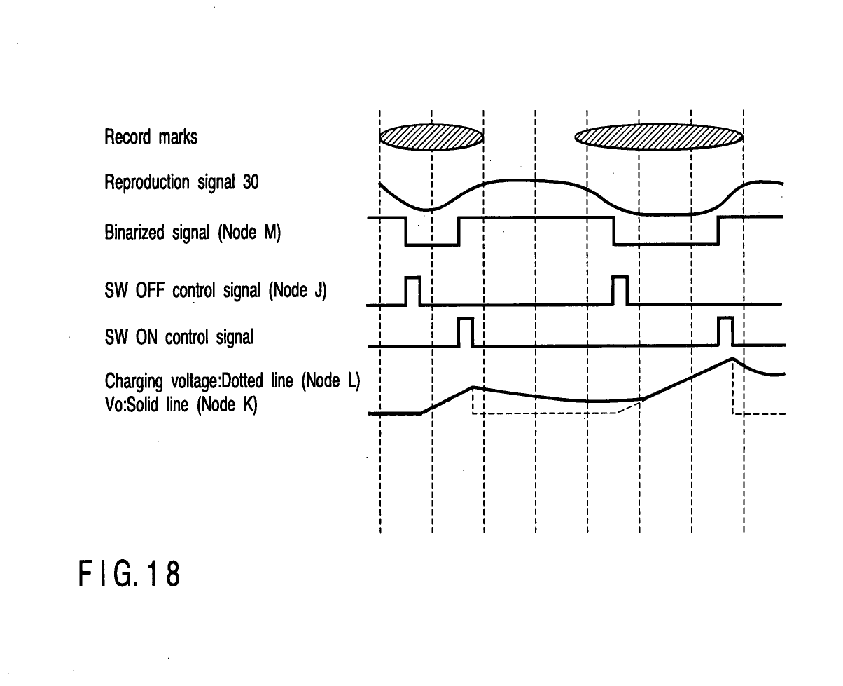

FIG. 18 shows signal waveforms in respective nodes of the area identifying circuit 28 shown in FIG. 17. A reproduction signal such as the reproduction signal 30 of FIG. 18 is obtained in accordance with the record mark, and a binarized signal of node M is generated. The falling-edge and the rising edge are detected at the edge determining circuit 35. A control signal is outputted to the switch from the edge determining circuit 35 such that the switch SW is turned off at the falling-edge and the SW is turned on at the rising-edge.

Due to the SW being turned on and off, a sawtooth charging voltage (dotted line) is generated at the node L. Because the first stage circuit 45 of the integrating circuit 39 is a voltage follower circuit, an electric potential which is the same as that at the node L is generated at the output side as well. Electric charges are accumulated in a capacitor C1 by the output electric current, and a peak electric potential thereof is generated as the output signal Vo. The C1 carries out discharging by an R1, and for example, when a state in which there are no record mark is continued for a long time at the connection area, this peak electric potential is made to be 0V. Because the product of the R1 and the C1 is in proportion to a discharge duration, a peak electric potential holding time is adjusted by adjusting a value of resistance of the R1 or the like.

Vo is analog-to-digital converted by the A/D converter 36, and is referred by the control unit 14. The control unit 14 reads out a threshold value from the semiconductor memory 14a, and compares the threshold value with Vo (ST22). The threshold value used in the method 3 is made to be an median value of the Vos which have been determined in advance at the system lead-in area 3 and the data lead-in area 4. When the Vo is greater than the threshold value, it is determined to be the system lead-in area 3 (ST6), and information is read out of the system lead-in area 3 (ST7), and the area identification and the readout of the system lead-in area 3 are completed. When the Vo is less than the threshold value, it is determined to be the data lead-in area 4 (ST8). The control unit 14 turns track servo off, and moves the optical pickup head 8 up to the burst cutting area 2 at the innermost peripheral side of the disk (ST9).

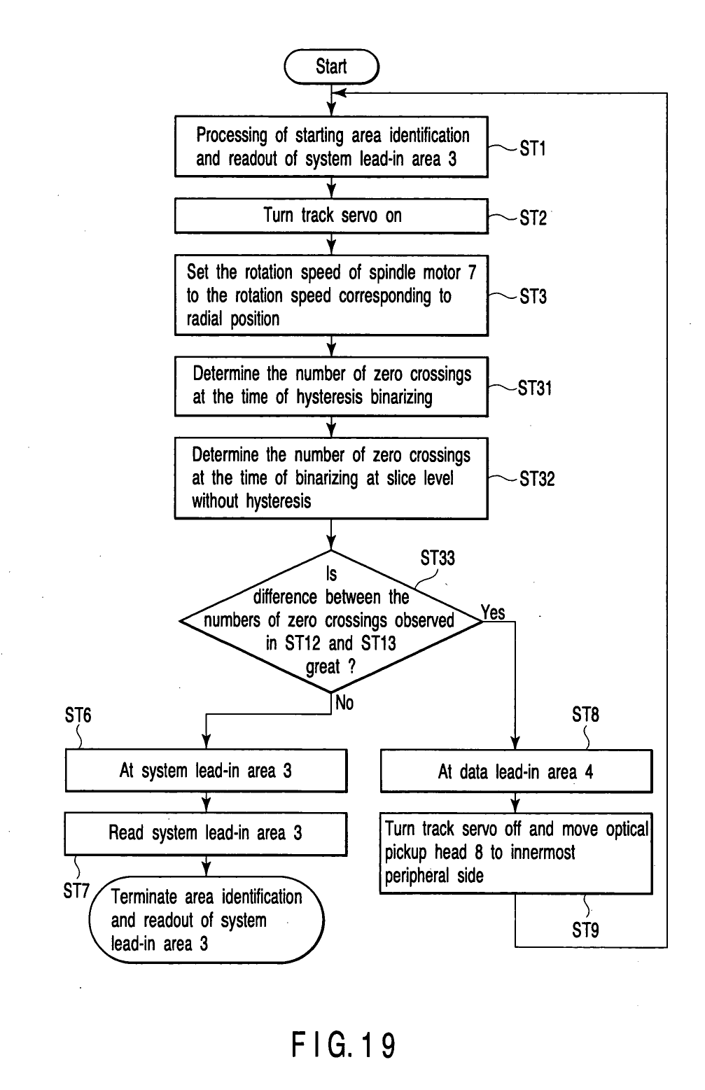

FIG. 19 is a flowchart showing processing up to the time when information is reproduced from the system lead-in area 3 by the use of a method (hereinafter, a method 4) for identifying based on the numbers of zero crossings of a signal in which the reproduction signal is binarized at a slice level with a hysteresis characteristic and a signal in which the reproduction signal is binarized at a slice level without a hysteresis characteristic, among the area identifying methods of the present invention. Hereinafter, the method 4 will be described.

Processing of starting area identification and system lead-in area readout (ST1) shows processing in which the control unit 14 moves the optical pickup head 8 to the vicinity of the system lead-in area 3 from the burst cutting area 2 in a state of the focus servo ON. Next, the control unit 14 turns track servo on (ST2), and sets the rotation speed of the spindle motor 7 to the rotation speed corresponding to the radial position of the information storage medium 1 (ST3). Next, the reproduction signal is binarized at a slice level with hysteresis, and the number of zero crossings is determined (S31). In the same way, the reproduction signal is binarized at a slice level without hysteresis, and the number of zero crossings is determined (S32).

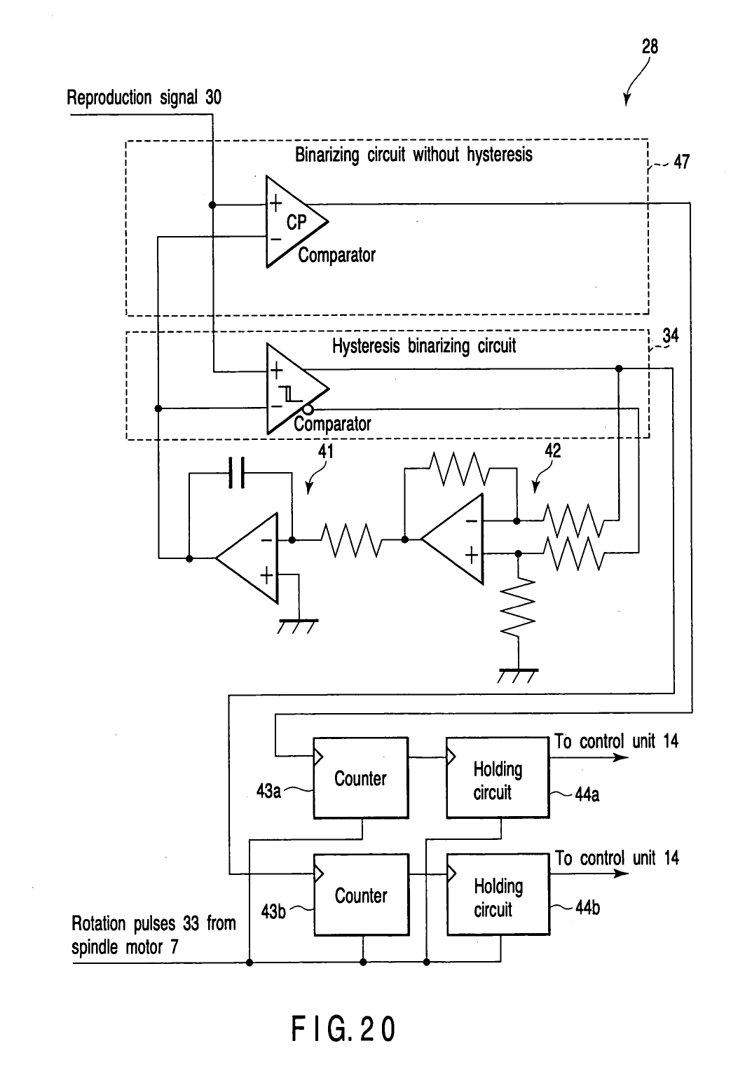

FIG. 20 is the area identifying circuit 28 used in the method 4. A hysteresis binarizing circuit 34 has two slice levels, and uses the two different slice levels when the electric potential of the reproduction signal 30 rises up and when the electric potential of the reproduction signal 30 falls down. There is the feature that the number of zero crossings of the reproduction signal 30 whose signal amplitude is unstable is reduced by using the hysteresis binarizing circuit 34. The low-frequency component superimposed onto the reproduction signal from the data lead-in area 4 is greater than that in the case of the system lead-in area 3 as described above. Accordingly, at the data lead-in area 4, a effective difference between the number of zero crossings when the reproduction signal is binarized by using a binarizing circuit 47 without hysteresis and the number of zero crossings when the reproduction signal is binarized by using the hysteresis binarizing circuit 34 is relatively large. On the other hand, at the system lead-in area 3, a effective difference between the number of zero crossings when the reproduction signal is binarized by using the binarizing circuit 47 without hysteresis and the number of zero crossings when the reproduction signal is binarized by using the hysteresis binarizing circuit 34 is relatively little. Discrimination between the areas is carried out based on a difference between these effective differences in the present embodiment.

The reproduction signal 30 is converted into a binarized signal by the hysteresis binarizing circuit 34, and moreover, the reproduction signal 30 is converted into a binarized signal by the binarizing circuit 47 without hysteresis, and the number of zero crossings per a predetermined rotation angle of the information storage medium 1 are determined by the respective counters 43a and 43b.

The predetermined rotation angle of the information storage medium 1 is arbitrarily determined. In order to obtain the information on the rotation, the rotation pulses 33 are inputted to the area identifying circuit 28 from the spindle motor 7. A effective difference between the two slice levels at the hysteresis binarizing circuit 34 is determined so as to have a significant difference between the both areas. Namely, the difference between the slice levels is determined so as to have a distinct difference when difference amount of the numbers of zero crossings counted by the two counters 43a and 43b in the area identifying circuit 28 in the method 4 are respectively compared at the system lead-in area 3 and the data lead-in area 4.

The control unit 14 reads two of the numbers of zero crossings from the area identifying circuit 28 used in the method 4, and calculates the difference amount. Next, the control unit 14 reads a threshold value of the difference amount of the numbers of zero crossings from the semiconductor memory 14a, and compares the threshold value with the difference amount which is the calculated result (ST33). As the threshold value used in the method 4, the difference amounts of the number of zero crossings by the hysteresis binarizing circuit 34 and the number of zero crossings by the binarizing circuit 47 without hysteresis are respectively determined at the system lead-in area 3 and the data lead-in area 4, and the threshold value is set to an median value thereof. When the difference amount is less than the threshold value, it is determined to be the system lead-in area 3 (ST6), and information is read out of the system lead-in area 3 (ST7), and the area identification and the readout of the system lead-in area 3 are completed. When the difference amount is less than the threshold value, it is determined to be the data lead-in area 4 (ST8). The control unit 14 turns track servo off, and moves the optical pickup head 8 up to the burst cutting area 2 at the innermost peripheral side of the disk (ST9).

Next, an embodiment in which information is reproduced from the data lead-in area 4 by using the connection area skipping circuit 29. In this embodiment, the track servo is turned off, the number of zero crossings of the track error signals from the system lead-in area 3, the connection area 5, and the data lead-in area 4 are identified in order, and the optical pickup head 8 skips over the connection area 5 (moves at a high-speed).

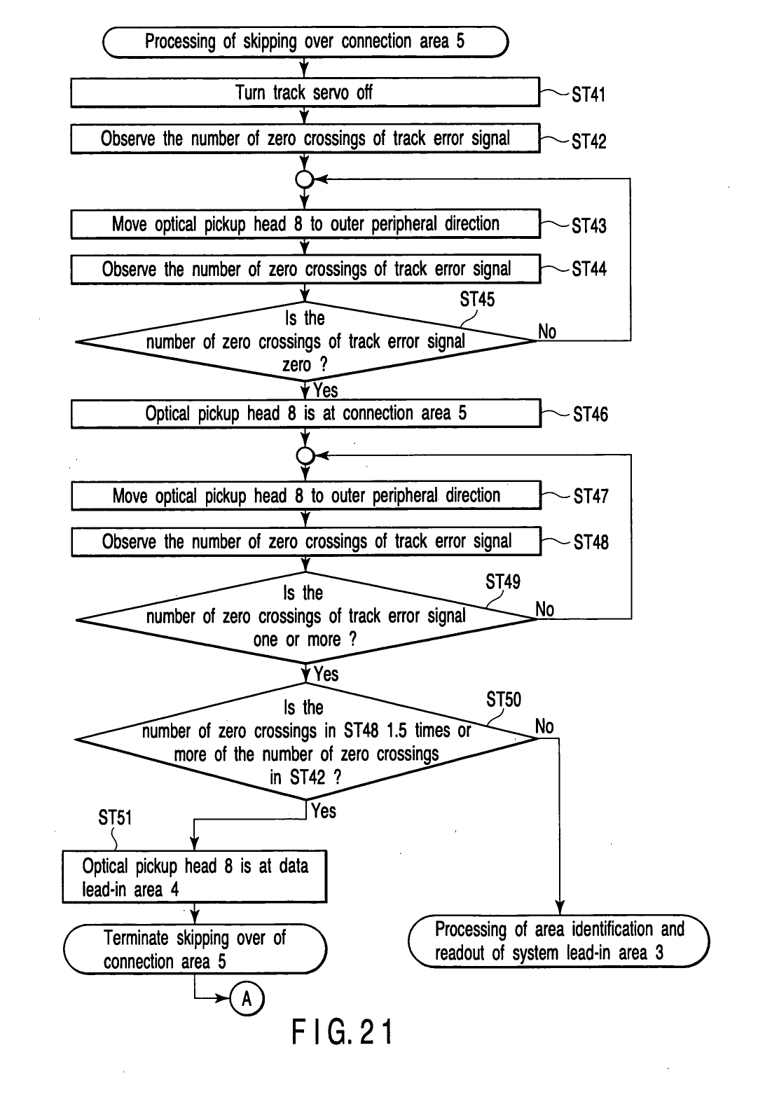

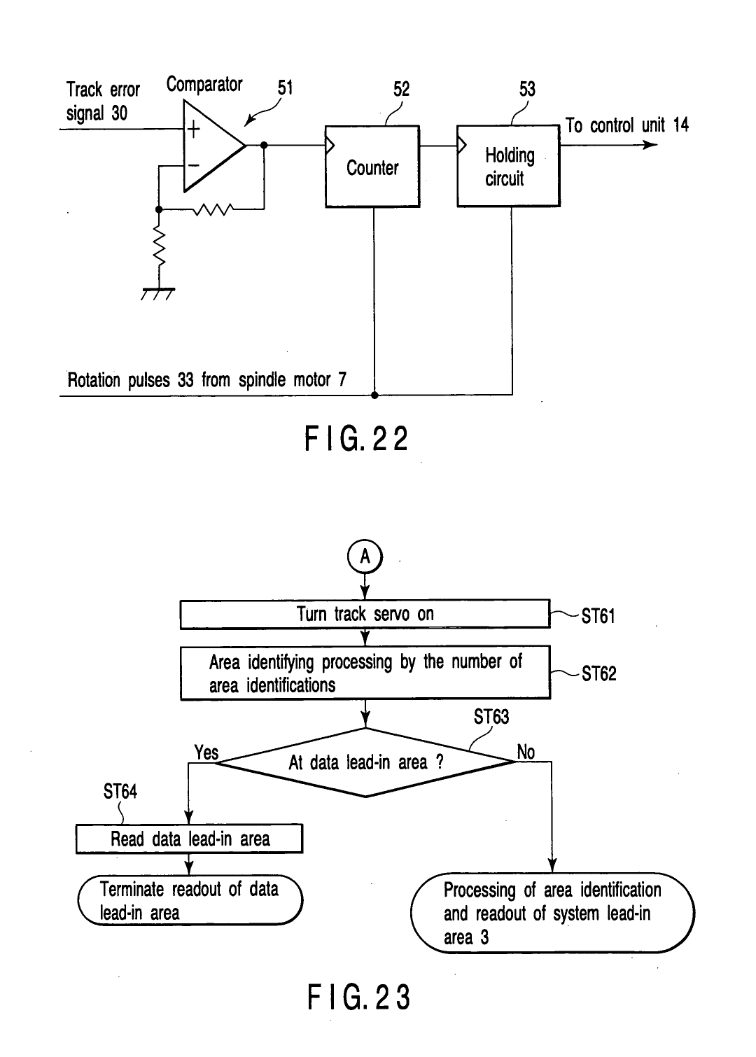

A track error signal outputted from the focus-track error detecting circuit 10 is inputted to the connection area skipping circuit 29 of FIG. 5. FIG. 21 is a flowchart showing a method for skipping over the connection area 5 according to the present embodiment, and FIG. 22 is a circuit diagram showing a configuration of the connection area skipping circuit 29.

As the above-described step ST7, after the area identification and the readout of the system lead-in area 3, the control unit 14 carries out processing of skipping over the connection area 5. First, the control unit 14 turns track servo off (ST41). In the skipping circuit 29, the track error signal is binarized by a comparator 51, and is counted by a counter 52, and the number of zero crossings per a predetermined rotation angle of the information storage medium 1 is maintained by a holding circuit 53 (ST42). The predetermined rotation angle of the information storage medium 1 is arbitrarily determined. In order to obtain the information on the rotation, the rotational pulses 33 are inputted to the connection area skipping circuit 29 from the spindle motor 7.

The control unit 14 moves the optical pickup head 8 to the direction of the outer periphery of the information storage medium 1 (ST43), and refers the number of zero crossings of the track error signal maintained by the holding circuit 53 of the connection area skipping circuit 29 (ST44). As a result of the reference, when the number of zero crossings is one or more, because it is understood that the beam spot of the optical pickup head 8 is at the system lead-in area 3, the control unit 14 notifies the feed motor driving circuit 13 of a movement instruction in order to further move the optical pickup head 8 to the direction of the outer periphery of the information storage medium 1 (ST43). When the number of zero crossings is zero, it is understood that the optical pickup head 8 is at the connection area 5 (ST46).

When the optical pickup head 8 reaches the connection area 5, the optical pickup head 8 is made to further move to the direction of the outer periphery of the information storage medium 1 (ST47). Next, the control unit 14 refers to the number of zero crossings of the track error signal which the connection area skipping circuit 29 has (ST48). As a result of the reference, when the number of zero crossings is zero, because it is understood that the optical pickup head 8 is at the connection area 5, the control unit 14 notifies the feed motor driving circuit 13 of a movement instruction in order to further move the optical pickup head 8 to the direction of the outer periphery of the information storage medium 1 (ST47). When the number of zero crossings is one or more, there is the possibility that the optical pickup head 8 is at the data lead-in area 4 (ST49).

Next, the control unit 14 refers the number of zero crossings obtained in step ST42 and the number of zero crossings obtained in step ST48, and determines whether the number of zero crossings obtained in step ST48 is 1.5 times or more of the number of zero crossings obtained in step ST42 (ST50). This “1.5 times” is a value determined based on a difference between the average frequencies of the reproduction signals from the system lead-in area 3 and the data lead-in area 4. In a case of 1.5 times or less, it is determined that the optical pickup head 8 is at the system lead-in area 3 or it is under the abnormal condition, and the routine returns to step ST1, and area identification and a system lead-in area 3 reading operation are started again. In a case of more than 1.5 times, it is determined that the optical pickup head 8 is at the data lead-in area 4 (ST51), the processing of skipping over the connection area 5 is completed, and the routine proceeds to processing such as processing of reproduced information on the data lead-in area 4, or the like. A value other than 1.5 times should be taken as the threshold value of the ratio of the number of zero crossings obtained at the data lead-in area 4 to the numbers of zero crossings obtained at the system lead-in area 3.

FIG. 23 is a flowchart showing processing after skipping over the connection area 5.

First, the control unit 14 turns track servo on (ST61), and confirms whether or not the light beam irradiation area is at the data lead-in area in accordance with one or a plurality of methods of the methods 1 through 4 described above by using the area identifying circuit 28 (ST62). When the light beam irradiation area is at the data lead-in area (in a case of YES in ST63), the control unit 14 carries out processing such as switching the parameters of the reproducing circuit 50, or the like, and reads out the information recorded on the data lead-in area (ST64), and when the necessary information is read out, the readout of the data lead-in area is completed. When it is determined that the light beam irradiation area is not at the data lead-in area in ST63, the control unit 14 determines that the optical pickup head 8 is at the system lead-in area 3 or it is under the abnormal condition, and returns to step ST1, and starts area identification and a system lead-in area 3 reading operation. Here, the control unit 14 turns track servo off, and moves the pickup head from the innermost periphery to the outermost periphery, and searches a track based on the numbers of zero crossings of the track error signal as that in step ST45, and when the track is detected, the control unit 14 may carry out area identification again by using the above-described methods 1 through 4.

In this way, in accordance with the present embodiment, because the optical pickup head 8 is moved in a state of the track servo OFF, even in a state in which the optical pickup head 8 has reached the connection area 5 and the track error signal cannot be detected, the connection area 5 can be skipped over under the stable control.

Further, because the data recorded on the respective areas are read out, and the connection area 5 can be skipped over without analyzing the data contents, a time from the time when the information reproducing apparatus and the information recording and reproducing apparatus are started up to the time when the readout of the data area is started can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical disk apparatus which carries out information reproducing from an optical disk having a system lead-in area, a connection area, and a data lead-in area, the apparatus comprising:
an optical pickup head which irradiates a light beam onto the optical disk, and provides a reproduction signal corresponding to a reflected light of the light beam, and which can be moved in a radial direction of the optical disk;
an identifying unit which identifies whether a light beam irradiation area of the optical pickup head is at one of the system lead-in area and the data lead-in area based on the reproduction signal provided from the optical pickup head; and
an information reproducing unit which reproduces information form the reproduction signal based on an identified result by the identifying unit.

2. An optical disk apparatus according to claim 1, wherein the identifying unit comprises:
a binarizing unit which binarizes the reproduction signal based on a slice level;
a counting unit which counts the number of zero crossings per a predetermined rotation angle of the optical disk based on a binarized signal obtained from the binarizing unit;
a storing unit which stores a threshold value calculated based on numbers of zero crossings of the binarized signals which have been determined in advance with respect to both areas of the system lead-in area and the data lead-in area;
a comparing unit which compares the number of zero crossings counted by the counting unit with the threshold value; and
a determining unit which determines the light beam irradiation area of the optical pickup head based on a compared result by the comparing unit.

3. An optical disk apparatus according to claim 1, wherein the slice level of the binarizing unit varies in accordance with a DC component in the reproduction signal.

4. An optical disk apparatus according to claim 1, wherein the identifying unit comprises:
a first binarizing unit which binarizes the reproduction signal by using a first slice level;
a first counting unit which counts the number of zero crossings of a binarized signal obtained from the first binarizing unit;
a second binarizing unit which binarizes the reproduction signal by using a second slice level which is different by a predetermined level from the first slice level;
a second counting unit which counts the number of zero crossings of a binarized signal obtained from the second binarizing unit; and
a comparing unit which compares the numbers of zero crossings of the binarized signals counted by the first counting unit and the second counting unit with one another, and
the identifying unit which identifies the light beam irradiation area of the optical pickup head based on a compared result by the comparing unit.

5. An optical disk apparatus according to claim 3, wherein the first and second slice levels vary in accordance with a DC component in the reproduction signal.

6. An optical disk apparatus according to claim 1, wherein the identifying unit comprises:
a measuring unit which measures a maximum value of length of record mark recorded on the disk from the reproduction signal; and
a comparing unit which compares a threshold value of maximum record mark lengths which have been determined in advance with respect to both areas of the system lead-in area and the data lead-in area with the maximum value of the record mark length measured by the measuring unit, and
the identifying unit identifies the light beam irradiation area of the optical pickup head based on a compared result by the comparing unit.

7. An optical disk apparatus according to claim 1, wherein the identifying unit comprises:
a first binarizing unit which binarizes the reproduction signal by using a binarizing circuit with hysteresis;
a first counting unit which counts the number of zero crossings of a binarized signal obtained from the first binarizing unit;
a second binarizing unit which binarizes the reproduction signal by using a binarizing circuit without hysteresis;
a second counting unit which counts the number of zero crossings of a binarized signal obtained from the second binarizing unit; and
a comparing unit which compares the number of zero crossings of the binarized signals counted by the first counting unit and the second counting unit each other, and
the identifying unit identifies the light beam irradiation area of the optical pickup head based on a compared result by the comparing unit.

8. An optical disk apparatus according to claim 1, comprising:
a generating unit which generates a track error signal based on the reproduction signal provided from the optical pickup head;
a track servo unit which carries out track servo based on the track error signal such that the light beam traces tracks on the disk, and which controls movement of the optical pickup head;
a binarizing unit which binarizes the track error signal;
a moving unit which moves the optical pickup head from the inner peripheral side to the outer peripheral side of the disk after turning the track servo off;
a counting unit which counts the number of zero crossings per the predetermined unit rotations of the track error signal when the optical pickup head is being moved by the moving unit; and
an identifying unit which identifies the light beam irradiation area in accordance with a counted result by the counting unit.

9. An optical disk apparatus according to claim 1, comprising:
a generating unit which generates a track error signal based on the reproduction signal provided from the optical pickup head;
a track servo unit which carries out track servo based on the track error signal such that the light beam traces tracks on the disk, and which controls movement of the optical pickup head;
a moving unit which moves the optical pickup head from the system lead-in area identified by the identifying unit to the outer peripheral side after turning the track servo off;
a counting unit which counts the number of zero crossings per a unit time of the track error signal when the optical pickup head is being moved by the moving unit; and
a control unit which determines that the light beam irradiation area is the connection area when the number of crossings is zero, and moreover, which moves the optical pickup head to the outer peripheral side, and turns track servo on when the number of crossings is made to be one or more, and carries out area identification by using the area identifying unit.

10. A method for reproducing information from an optical disk having a system lead-in area, a connection area, and a data lead-in area, the method comprising:
irradiating a light beam onto the optical disk, and identifying whether a light beam irradiation area of the optical pickup head is at the system lead-in area or at the data lead-in area based on a reproduction signal corresponding to a reflected light of the light beam; and
reproducing information form the reproduction signal based on an identified result.

11. A method for reproducing information, according to claim 10, wherein the identifying includes:
binarizing the reproduction signal based on a slice level;
counting the number of zero crossings per a predetermined rotation angle of the optical disk of a binarized signal obtained by the binarizing;
comparing a threshold value calculated based on number of zero crossings of the binarized signals which have been determined in advance with respect to both areas of the system lead-in area and the data lead-in area with the number of zero crossing counted by the counting, and
the identifying identifies the light beam irradiation area of the optical pickup head based on a compared result by the comparing.

12. A method for reproducing information, according to claim 10, comprising:
generating a track error signal based on the reproduction signal provided from the optical pickup head;
carrying out track servo based on the track error signal such that the light beam traces tracks on the disk, and controlling movement of the optical pickup head;
binarizing the track error signal;
moving the optical pickup head from the inner peripheral side to the outer peripheral side of the disk after turning the track servo off;
counting the number of zero crossings per the predetermined unit rotations of the track error signal when the optical pickup head is being moved by the moving; and
identifying the light beam irradiation area in accordance with a counted result by the counting.
